(19) United States
(12) Patent Application Publication
(10) Pub. No.: US 2021/0342605 A1
(43) Pub. Date: Nov. 4, 2021

(54) METHOD AND SYSTEM FOR IDENTIFYING OBSTACLES

(71) Applicant: BAYERISCHE MOTOREN WERKE AKTIENGESELLSCHAFT, Munich (DE)

(72) Inventors: Marc WALESSA, Munich (DE); Andre ROSKOPF, Munich (DE); Andreas ZORN-PAULI, Petershausen (DE); Ting LI, Munich (DE); Christian RUHHAMMER, Postmuenster (DE); Gero GREINER, Munich (DE)

(21) Appl. No.: 17/255,539

(22) PCT Filed: Jun. 18, 2019
(86) PCT No.: PCT/DE2019/100558

§ 371 Date: Dec. 23, 2020

(30) Foreign Application Priority Data
Jun. 30, 2018 (DE) 10 2018 115 895.5

(51) Int. Cl. G06K 9/00; B60W 30/095; B60W 40/02; G06K 9/62

(52) U.S. Cl. CPC G06K 9/00805; B60W 30/0956; G06K 9/6223; G06K 9/6215; B60W 40/02

(57) ABSTRACT

The present disclosure relates to a method for detecting one or more objects in an environment of a vehicle, the environment being bounded by a perimeter, the method comprising: segmenting the environment into a plurality of segments such that each segment of the plurality of segments is at least partially bounded by the perimeter of the environment; detecting one or more detection points based on the one or more objects in the environment of the vehicle; combining the one or more detection points into one or more clusters based on a spatial proximity of the one or more detection points; and assigning a state to each of the segments of the plurality of segments based on the one or more detected detection points and/or based on the one or more combined clusters. The present disclosure further relates to a system for detecting one or more objects in a vehicle environment and a vehicle comprising the system.

The disclosure relates to methods and systems for the detection of obstacles. The disclosure relates in particular to methods and systems for detecting static obstacles in the environment of vehicles.

### PRIOR ART

Various methods and systems for the detection of obstacles (i.e. generally of objects) in the environment of vehicles are known in the prior art. The environment of a vehicle is detected by means of various sensors here and, based on the data supplied by the sensor system, it is determined whether there are any obstacles in the environment of the vehicle and, if necessary, their position is determined. The sensor technology used for this purpose typically includes sensors that are present in the vehicle, for example ultrasonic sensors (e.g. PDC and/or parking aid), one or more cameras, radar (e.g. speed control with distance keeping function) and the like. Typically, a vehicle contains different sensors that are optimized for specific tasks, for example with regard to detection range, dynamic aspects and requirements with respect to accuracy and the like.

The detection of obstacles in the vehicle environment is used for different driver assistance systems, for example for collision avoidance (e.g. Brake Assist, Lateral Collision Avoidance), lane change assistant, steering assistant and the like.

For the detection of static obstacles in the environment of the vehicle, fusion algorithms are required for the input data of the different sensors. In order to compensate for sensor errors, such as false positive detections (e.g. so-called ghost targets) or false negative detections (e.g. undetected obstacles) and occlusions (e.g. caused by moving vehicles or limitations of the sensor'S field of view), tracking of sensor detections of static obstacles is necessary.

Different models are used to map the immediate environment around the vehicle. A method known in the prior art for detecting static obstacles is the Occupancy Grid Fusion (OGF). In OGF, the vehicle environment is divided into rectangular cells. For each cell, a probability of occupancy with respect to static obstacles is calculated during fusion. The size of the cells determines the accuracy of the environmental representation.

S. Thrun and A. Bücken, “Integrating grid-based and topological maps for mobile robot navigation,” in Proceedings of the Thirteenth National Conference on Artificial Intelligence -Volume 2, Portland, Oreg., 1996, describe research in the field of mobile robot navigation and essentially two main paradigms for mapping indoor environments: grid-based and topological. While network-based methods generate accurate metric maps, their complexity is often unable to plan efficiently and solve problems in large indoor spaces. Topological maps on the other hand may be used much more efficiently, but accurate and consistent topological maps are difficult to learn in large environments. Thrun and Bücken describe an approach that integrates both paradigms. Grid-based maps are learned with artificial neural networks and Bayesian integration. Topological maps are generated as a further superordinate level on the grid-based maps by dividing the latter into coherent regions. The integrated approaches described are not easily applicable to scenarios whose parameters deviate from the indoor environments described.

With regard to application in the vehicle, OGF-based methods comprise at least the following disadvantages. A representation that comprises a high accuracy requires a correspondingly large number of comparatively small cells and thus causes a high calculation effort and places high demands on the available storage capacity. For this reason, efficient detection of static obstacles by means of OGF is often imprecise, since, due to the nature of the method, an increase in efficiency may practically only be achieved by using larger cells, at the expense of accuracy.

As in the present case of an obstacle detection application in vehicles, many applications require a more accurate representation of the surrounding area in the immediate environment, whereas a less accurate representation is sufficient at medium to greater distances. These requirements are typical for the concrete application described here and are reflected in the available sensor technology. Typically, the accuracy of the sensor technology used decreases with increasing distance, so that sufficient and/or desired accuracy is available in the close range, but not in the further away range. These properties may not be mapped with an OGF because the cells are stationary. This means that a cell may represent a location that is in the close range at one point in time, but in the far range at another point in time.

Embodiments of the methods and systems disclosed here will partially or fully remedy one or more of the aforementioned disadvantages and enable one or more of the following advantages.

Presently disclosed methods and systems enable an improved detection of obstacles and/or objects in the environment of vehicles. In particular, the disclosed methods and systems enable a simultaneous improvement in efficiency and accuracy of the detection of obstacles and/or objects in the environment of vehicles. Presently disclosed methods and systems further enable a differentiated observation of objects depending on the distance to the vehicle, so that closer objects may be detected more precisely and more distant objects with sufficient accuracy and high efficiency. Presently disclosed methods and systems further enable an efficient detection of all objects based on a relative position of the objects to the vehicle, so that objects of primary importance (e.g. objects in front of the vehicle) may be detected precisely and efficiently and objects of secondary importance (e.g. lateral objects or objects in the rear of the vehicle) may be detected with sufficient precision and in a resource-saving manner.

### DISCLOSURE OF THE INVENTION

It is an object of the present disclosure to provide methods and systems for the detection of obstacles in the environment of vehicles, which avoid one or more of the above-mentioned disadvantages and realize one or more of the above-mentioned advantages. It is further an object of the present disclosure to provide vehicles with such systems that avoid one or more of the above mentioned disadvantages and realize one or more of the above mentioned advantages.

This object is solved by the respective subject matter of the independent claims. Advantageous implementations are indicated in the subclaims.

According to embodiments of present disclosure, in a first aspect a method for detecting one or more objects in an environment of a vehicle is given, the environment being bounded by a perimeter. The method comprises segmenting the environment into a plurality of segments such that each segment of the plurality of segments is at least partially bounded by the perimeter of the environment, detecting one or more detection points based on the one or more objects in the environment of the vehicle, combining the one or more detection points into one or more clusters based on a spatial proximity of the one or more detection points, and assigning a state to each of the segments of the plurality of segments. The step of assigning a state to each of the segments of the plurality of segments is based on the one or more detected detection points and/or (i.e., additionally or alternatively) on the one or more combined clusters.

Preferably, in a second aspect according the previous aspect 1, the environment includes an origin, the origin optionally coinciding with a position of the vehicle, in particular a position of the centre of a rear axle of the vehicle.

Preferably, in a third aspect according to the previous aspect 2, each segment of a first subset of the plurality of segments is defined in terms of a respective angular aperture originating from the origin, the first subset comprising one, more, or all segments of the plurality of segments.

Preferably, in a fourth aspect according to the previous aspect 3, the segments of the first subset comprise at least two different angular apertures, wherein in particular: Segments extending substantially laterally of the vehicle comprise a larger angular aperture than segments extending substantially in a longitudinal direction of the vehicle; or segments extending substantially laterally of the vehicle comprise a smaller angular aperture than segments extending substantially in a longitudinal direction of the vehicle.

Preferably, in a fifth aspect according to one of aspects 3 or 4, the segments of the first subset comprise an angular aperture originating from the origin substantially in the direction of travel of the vehicle.

Preferably, in a sixth aspect according to one of the preceding aspects 1 to 5 and aspect 3, each segment of a second subset of the plurality of segments is defined in terms of a cartesian subsection, wherein the second subset, possibly based on the first subset, comprises one, more, or all segments of the plurality of segments.

Preferably, in a seventh aspect according to the previous aspect 6, the segments of the second subset comprise at least two different extensions in one dimension.

Preferably, in an eighth aspect according to one of the two preceding aspects 6 and 7, the segments of the second subset comprise a first extension substantially transverse to a direction of travel of the vehicle which is greater than a second extension substantially in a direction of travel of the vehicle.

Preferably, in a ninth aspect according to the previous aspects 3 and 6, the segments of the first subset are defined on one side of the origin 84 and the segments of the second subset are defined on an opposite side of the origin. In particular, the segments of the first subset are defined starting from the origin in the direction of travel of the vehicle.

Preferably, in a tenth aspect according to one of the previous aspects 1 to 9, the combining of the one or more detection points into one or more clusters is based on the application of the Kalman filter.

Preferably, in an eleventh aspect according to the previous aspect, the one or more clusters are treated as one or more detection points.

Preferably, in a twelfth aspect according to any of the preceding aspects, the state of a segment of the plurality of segments indicates an at least partial overlap of an object with the respective segment, wherein preferably the state includes at least one discrete value or one probability value.

Preferably, in a thirteenth aspect according to any of the previous aspects, the vehicle includes a sensor system configured to detect the objects in the form of detection points.

Preferably, in a fourteenth aspect according to the previous aspect, the sensor system comprises at least a first sensor and a second sensor, wherein the first and second sensors are configured to detect objects, optionally wherein the first and second sensors are different from each other and/or wherein the first and second sensors are selected from the group comprising ultrasonic-based sensors, optical sensors, radar-based sensors, lidar-based sensors.

Preferably, in a fifteenth aspect according to the previous aspect, detecting the one or more detection points further includes detecting the one or more detection points by means of the sensor system.

Preferably, in a sixteenth aspect according to any of the previous aspects, the environment essentially comprises one of the following forms: Square, rectangle, circle, ellipse, polygon, trapeze, parallelogram.

According to embodiments of present disclosure, in a seventeenth aspect a system for detecting one or more objects in an environment of a vehicle is given. The system comprises a control unit and a sensor technology, wherein the control unit is configured to execute the method according to any of the preceding aspects.

According to embodiments of the present disclosure, in an eighteenth aspect a vehicle is given, comprising the system according to the previous aspect.

### BRIEF DESCRIPTION OF THE DRAWINGS

Embodiments of the disclosure are shown in the figures and are described in more detail below.

FIG. 1 shows an example of a schematic representation of an environment of a vehicle and of objects and/or obstacles present in the environment;

FIG. 2 shows a schematic representation of the application of an OGF-based detection of obstacles in the environment of a vehicle;

FIG. 3 shows a schematic representation of the detection of objects in the environment of a vehicle according to embodiments of the present disclosure;

FIG. 4 shows an exemplary segment-based fusion of objects according to embodiments of the present disclosure; and

FIG. 5 shows a flowchart of a method for detecting objects in the environment of a vehicle according to embodiments of the present disclosure.

### EMBODIMENTS OF THE DISCLOSURE

In the following, unless otherwise stated, the same reference numerals are used for identical elements and elements having the same effect.

FIG. 1 shows an example of a schematic representation of an environment 80 of a vehicle 100 and of objects 50 and/or or obstacles present in the environment 80. The vehicle 100, shown here exemplarily as a passenger car in a plan view with direction of travel to the right, is located in an environment 80 existing around the vehicle 100. The environment 80 comprises an area around the vehicle 100, wherein a suitable spatial definition of the environment may be assumed depending on the application. According to the embodiments of the present invention, the environment has an extent of up to 400 m length and up to 200 m width, preferably up to 80 m length and up to 60 m width.

Typically, an environment 80 is considered whose extent in the longitudinal direction, i.e. along a direction of travel of the vehicle 100 is greater than in the direction transverse to it. Furthermore, the environment in front of vehicle 100 in the direction of travel may have a greater extent than behind the vehicle 100. Preferably, the environment 80 has a speed-dependent extent, so that a sufficient foresight of at least two seconds, preferably at least three seconds, is made possible.

As exemplified in FIG. 1, the environment 80 of the vehicle 100 may contain a number of objects 50, which in the context of this disclosure may also be called “obstacles”. Objects 50 represent areas of the environment 80 that may not or should not be used by vehicle 100. Furthermore, the objects may have 50 different dimensions and/or shapes and/or be located in different positions. Examples of objects 50 and/or obstacles may be other road users, especially stationary traffic, constructional restrictions (e.g. curbs, sidewalks, guard rails) or other limitations of the roadway.

FIG. 1 shows the environment 80 in the form of a rectangle (see perimeter 82). However, the environment 80 may take any suitable shape and size suitable for a representation of the same, for example, square, elliptical, circular, polygonal, or the like. The perimeter 82 is configured to delimit the environment 80. This allows objects 50 which are further away to be excluded from detection. Furthermore, the environment 80 may be adapted to a detection range of the sensor system. Preferably, the environment 80 corresponds to a shape and size of the area that may be detected by the sensor system installed in the vehicle 100 (not shown in FIG. 1). In addition, the vehicle 100 may include a control unit 120 in data communication with the vehicle sensor system which is configured to execute steps of method 500.

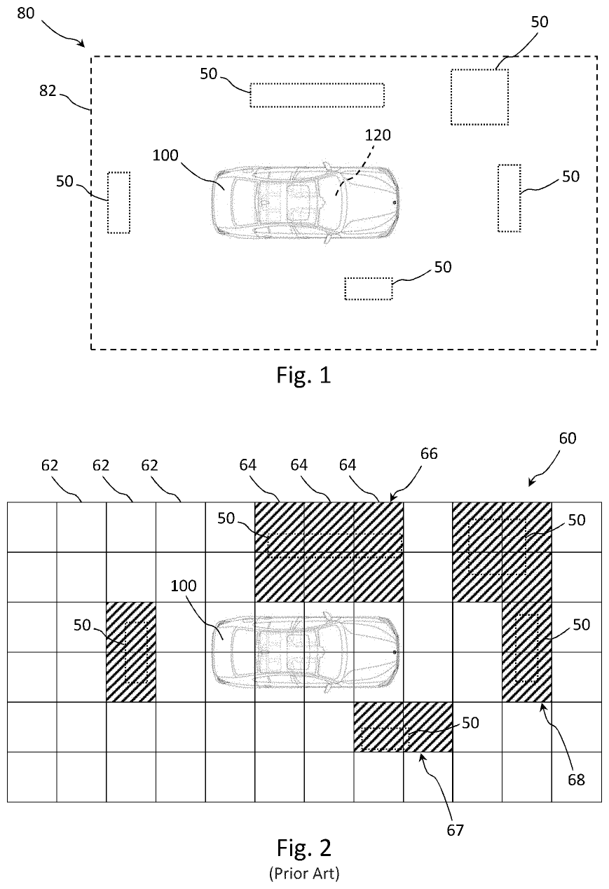

FIG. 2 shows a schematic representation of the application of an OGF-based detection of obstacles 50 in the environment 80 of a vehicle 100 according to the prior art. For simplicity, FIG. 2 shows the same objects 50 in relation to the vehicle 100 as FIG. 1. In addition, FIG. 2 shows a grid structure 60 superimposed on the environment 80, which is used to perform an exemplary division of the environment 80 into cells 62, 64. Here, hatched cells 64 mark the subareas of the grid structure 60 that at least partially contain an object 50. On the other hand, cells 62 marked as “free” are shown without hatching.

FIG. 2 clearly shows that the size of the cells 62, 64 is in several respects essential for the detection of the objects 50. Based on the grid structure 60, a cell 64 may be marked as occupied if it at least partially overlaps with an object 50. In the example shown, group 66 of cells 64 may therefore be marked as occupied, although the effective (lateral) distance of the object 50 detected by group 66 to the vehicle 100 is much greater than the distance of group 66. A precise determination of distances to objects 50 based on the grid structure would therefore require relatively small cells. In some cases, grid-based methods also use probabilities and/or “fuzzy” values, so that one or more cells may also be marked in such a way that the probability of an occupancy is detected (e.g. 80% or 30%) or a corresponding value is used (e.g. 0.8 or 0.3) instead of a discrete evaluation (e.g. “occupied” or “not occupied”). Such aspects do not change the basic conditions, for example with regard to cell size.

Furthermore, a precise determination of an effective size of an object 50 or conclusions about its shape, as shown in FIG. 2, also depends on a suitable (small) cell size. For example, the groups 66 and 67 of cells 64 contain (in terms of group size) relatively small objects 50, while group 68 contains not only one object 50 but two of them. Conclusions about the size, shape, and/or number of objects in a respective, coherent group 66, 67, 68 of cells 64 are therefore only possible to a limited extent and/or with relative inaccuracy on the basis of the grid structure shown.

As already described, a smaller cell size requires correspondingly more resources for the detection and/or processing of object data, so that higher accuracy is typically associated with disadvantages in terms of efficiency and/or resource requirements.

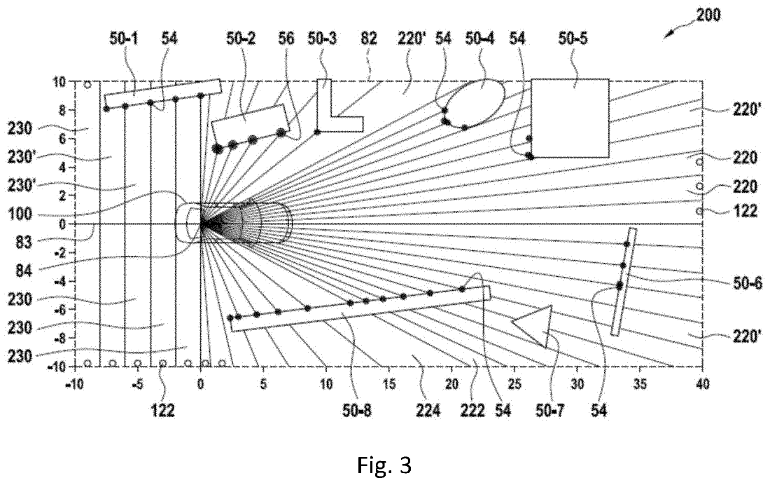

FIG. 3 shows a schematic representation of the detection of objects 50 in the environment 80 of a vehicle 100 according to embodiments of the present disclosure. Embodiments of the present disclosure are based on a fusion the characteristics of static objects 50 (and/or obstacles) in a vehicle-fixed, segment-based representation. An exemplary vehicle-proof, segment-based representation is shown in FIG. 3. The environment 80 of the vehicle 100 is limited by the perimeter 82. For the purposes of illustration, the environment 80 in FIG. 3, analogous to that shown in FIG. 1, is also shown in the form of a rectangle, without the environment 80 being fixed to such a shape or size (see above).

The segment-based representation may consist of cartesian or polar or mixed segments. FIG. 3 shows a representation based on mixed segments 220, 230. The origin 84 of the coordinate network may be placed substantially at the center of the rear axle of the vehicle 100, as shown in FIG. 3, to define the representation vehicle-fixed. According to the disclosure, however, other definitions and/or relative positionings are possible.

When different components and/or concepts are spatially related to the vehicle 100, this is done relative to a longitudinal axis 83 of the vehicle 100 extending along and/or parallel to an assumed direction of forward travel. In FIGS. 1 to 3, the assumed direction of travel of the vehicle is 100 forward to the right, the longitudinal axis 83 being shown in FIG. 3. Accordingly, a transverse axis of the vehicle shall be understood to be perpendicular to the longitudinal axis 83. Thus, for example, the object 50-2 is located laterally and/or abeam to the vehicle 100 and the object 50-6 is essentially in front of the vehicle 100 in the direction of travel.

Starting from the origin 84 of the coordinate grid, the environment 80 is divided and/or segmented into polar segments 220 in the direction of travel (to the right in FIG. 3), so that each segment 220 is defined by an angle (and therefore an angular opening) located at the origin and the perimeter 82 of the environment 80. Here, as shown in FIG. 3, different segments 220 may be defined using angles and/or angular openings of a different size. For example, the segments 220, which essentially cover the environment abeam to the vehicle 100 (and/or lateral to the direction of travel), comprise larger angles than those segments 220, which cover the environment 80 essentially in the direction of travel. In the example illustrated in FIG. 3, the laterally-longitudinally different segmentation (larger angles abeam, smaller angles in longitudinal direction) results in a more accurate resolution in the direction of travel, while a lower resolution is applied abeam. In other embodiments, for example if a different prioritization of the detection accuracy is desired, the segmentation may be adjusted accordingly. In examples, in which the detection abeam is to be carried out with higher resolution, the segmentation abeam may have smaller opening angles (and/or narrower segments).

In addition, the environment 80, starting from the origin 84 of the coordinate grid against the direction of travel (in FIG. 3, to the left of the vehicle 100), is segmented into cartesian segments 230, so that each segment 230 is defined by a rectangle bounded on one side by the axis 83 (passing through the origin 84 and parallel to the direction of travel) and on the other side by the perimeter 82. A width of the (rectangular) segments 230 may be set appropriately and/or be defined by a predetermined value.

A segmentation of the environment 80 by different segments 220, 230 (e.g. polar and cartesian) may allow an adaptation to different detection modalities depending on the specific application. For example, the detection of objects 50 in the environment 80 of the vehicle 100 in the direction of travel may have a greater accuracy and range than the detection of objects 50 in the environment 80 of the vehicle 100 against the direction of travel (e.g. behind the vehicle) or to the side of the vehicle 100.

Methods according to the present disclosure make it possible to represent obstacles over a continuous size as a distance within a segment in relation to an origin. In addition to the distance, the angle of a detected obstacle may be detected and taken into account. In particular, this enables improved accuracy of obstacle detection compared to known methods. In addition, according to the present disclosure, methods allow the fusion of different detections of an obstacle (by one or more sensors). An association and/or grouping of the detections may be based on the properties of the individual detections (variance and/or uncertainty). This also improves the precision of the detection compared to known methods.

Known methods may involve a comparatively trivial combination of several detection points, for example by means of a polyline. However, such a combination is fundamentally different from the combination and/or fusion of individual detections described in the present disclosure. A combination, for example using a polyline, corresponds to an abstract representation of an obstacle and/or a detection of a shape or even an outline. Methods according to the present disclosure make it possible to combine and/or merge different detections of the exact same feature or element of a coherent obstacle. In particular, this enables an even more precise determination of the existence and/or position of individual components of an obstacle.

FIG. 3 shows an exemplary segmentation for the purpose of illustrating embodiments according to the disclosure. In other embodiments, other segmentations may be applied, for example, based only on polar or only on Cartesian coordinates and, deviating from what is shown in FIG. 3, based on mixed coordinates.

In general, a segment 220, 230 may contain none, one or more objects 50. In FIG. 3, segments 220, 230, which contain one or more objects 50 are called segments 220′ and/or 230′ respectively. The area represented by a segment 220, 230 is limited at least on one side by the perimeter 82 of the environment 80. In particular, a polar representation maps the property that the accuracy decreases with distance. This is due to the fact that the polar representation, i.e. the radiation-based segmentation starting at origin 84, covers an increasingly large area with increasing distance from origin 84, while comparatively small sections, and thus areas, are considered proximally to the origin 84.

Based on the sensor technology of the vehicle 100, i.e. based on the signals of one or more sensors, no, one or more detection points 54, 56 are detected in a segment. When several sensors are used, there are typically different ranges of vision and/or detection that allow reliable and/or more reliable detection of objects 50. Objects 50 that may not be detected by one sensor or may only be detected with difficulty (e.g. based on a limited detection range, the type of detection and/or interference) may often be reliably detected by another sensor. During the detection, detection points are registered which may be classified locally in the coordinate system.

The sensor system of the vehicle 100 preferably includes one or more sensors selected from the group including ultrasonic sensors, lidar sensors, optical sensors and radar-based sensors.

Cyclically, obstacle points that are close to each other may be associated together in each time step and fused with respect to their properties (e.g. position, probability of existence, height, etc.). The result of this fusion is stored in the described representation and tracked and/or traced over time by means of vehicle movement (cf. “tracking” in the sense of following, tracing). The results of fusion and tracking serve as further obstacle points in the following time steps in addition to new sensor measurements.

Tracking and/or tracing describes a continuation of the already detected objects 50 and/or the detection points 54, 56 based on a change of position of the vehicle. Here, a relative movement of the vehicle (e.g. based on dead reckoning and/or odometry sensor technology, or GPS coordinates) is mapped accordingly in the representation.

An essential advantage of the methods according to the present embodiment is that a respective state of a segment is not related and/or tracked to sector segments, but to any detected obstacles. Furthermore, flexible states such as probabilities or classification types may be tracked as information. Known methods typically only consider discrete states (e.g. occupied or not occupied), which only comprise an abstract reference but do not represent any properties of detected obstacles.

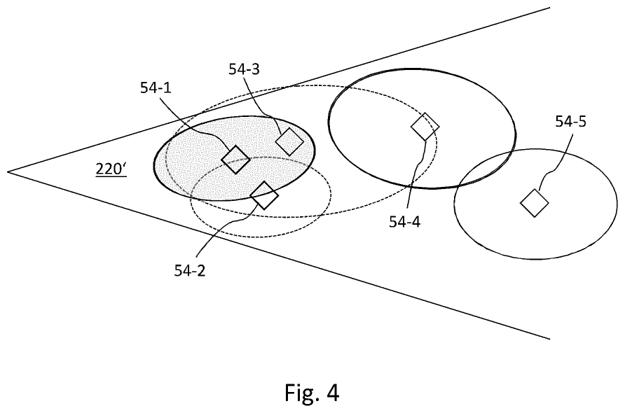

FIG. 4 shows an exemplary segment-based fusion of objects 54-1, 54-2, 54-3, 54-4, 54-5 according to embodiments of the present disclosure. FIG. 4 shows a segment 220′ with the exemplary detection of five detection points 54-1, 54-2, 54-3, 54-4 and 54-5. Preferably, one or more of the detection points are detected based on signals from different sensors. The rhombs mark the detected object positions approximated as detection points and the respective ellipses correspond to a two-dimensional positional uncertainty (variance). Depending on the sensor technology, a different variance may be assumed, and/or an estimated variance may be supplied by the respective sensor for each detection.

Starting with the nearest object 54-1, a cluster of objects is created by grouping all objects within the two-dimensional positional uncertainty of object 54-1. The cluster with the objects 54-1, 54-2 and 54-3 is created. No further objects may be assigned to objects 54-4 and 54-5. For this reason, each of them forms its own cluster. Within a cluster, the position is fused, for example, using Kalman filters, and the probability of existence using Bayes or Dempster-Shafer.

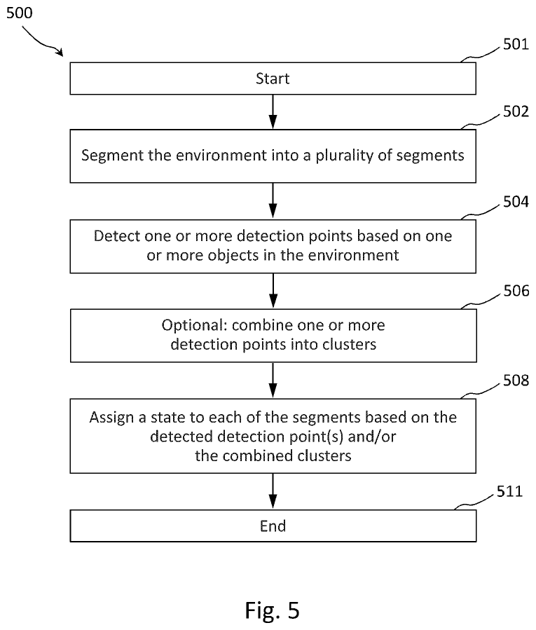

FIG. 5 shows a flowchart of a method 500 for detecting objects 50 in an environment 50 of a vehicle 100 according to embodiments of the present disclosure. The method 500 starts at step 501.

In step 502 the environment 80 is divided and/or segmented into a plurality of segments such that each segment 220, 230 of the plurality of segments is at least partially bounded by the perimeter 82 of the environment 80. This means (cf. FIG. 3) that each of the segments is at least partially bounded by the perimeter 82 and thus the environment is fully covered by the segments. In other words, the sum of all segments 220, 230 corresponds to the environment 80, the areas are identical and/or congruent. Furthermore, each segment has “contact” to the perimeter 82 and/or to the edge of the environment, so that no segment is isolated within the environment 80 or separated from the perimeter 82. In other words, at least a portion of the perimeter of each segment 220, 230 coincides with a portion of the perimeter 82 of the environment 80.

In step 504 one or more detection points 54, 56 are detected based on the one or more objects 50 in the environment 80 of the vehicle 100. Based on the sensor technology of the vehicle 100 detection points of the object(s) are detected as points (e.g. coordinates, position information), preferably relative to the vehicle 100 or in another suitable reference frame. The detection points 54, 56 detected in this way thus mark positions in the environment of 80 of the vehicle 100 at which an object 50 and/or a partial area of the object has been detected. As may be seen in FIG. 3, several detection points 54, 56 may be detected for one object each, wherein an object 50 may be detected more precisely the more detection points 54, 56 are detected and if different types of sensors (e.g. optical, ultrasonic) are used for detection, so that sensor-related and/or technical influences (e.g. visibility and/or detection areas, resolution, range, accuracy) are minimized.

Optionally, in step 506, one or more detection points 54, 56 are combined into clusters based on a spatial proximity of the points to each other. As described with respect to FIG. 4, any possibly existing positional uncertainties may be reduced and/or avoided in this way, so that objects 50 may be detected with an improved accuracy based on the resulting clusters of the detection points.

In step 508, each of the segments 220, 230 of the plurality of segments is assigned a state based on the one or more detection points 54, 56 and/or the detected clusters. If no clusters have been formed, step 508 is based on the detected detection points 54, 56. Optionally, step 508 may be based additionally or alternatively on the detected clusters, with the aim of enabling the highest possible detection accuracy and providing segments with a state accordingly. In particular, the state indicates a relation of the segment with one or more obstacles. According to the embodiments of the present disclosure, the state may take a discrete value (e.g., “occupied” or “unoccupied”, and/or suitable representations such as “0” or “1”) or a floating value (e.g., values expressing a probability of occupancy, such as “30%” or “80%”, and/or suitable representations such as “0.3” or “0.8”; or other suitable values, e.g., discrete levels of occupancy, such as “strong”, “medium”, “weak”).

If we are talking about a vehicle in this case, it is preferably a multi-track motor vehicle (car, truck, van). This results in several advantages explicitly described in this document as well as several other advantages that are comprehensible to the person skilled in the art.

Although the invention has been illustrated and explained in detail by preferred embodiments, the invention is not restricted by the disclosed examples and other variations may be derived by the person skilled in the art without leaving the scope of protection of the invention. It is therefore clear that there is a wide range of possible variations. It is also clear that examples of embodiments are really only examples which are not in any way to be understood as a limitation of the scope of protection, the possible applications or the configuration of the invention. Rather, the preceding description and the description of the figures enable the person skilled in the art to implement the exemplary embodiments in a concrete way, wherein the person skilled in the art, being aware of the disclosed inventive step, may make various changes, for example with regard to the function or the arrangement of individual elements mentioned in an exemplary embodiment, without leaving the scope of protection defined by the claims and their legal equivalents, such as further explanations in the description.

1. A method of detecting one or more objects in an environment of a vehicle, the environment being bounded by a perimeter, the method comprising:
segmenting the environment into a plurality of segments such that each segment of the plurality of segments is at least partially bounded by the perimeter of the environment;
detecting one or more detection points based on the one or more objects in the environment of the vehicle;
combining the one or more detection points into one or more clusters based on a spatial proximity of the one or more detection points; and
assigning a state to each of the segments of the plurality of segments based on the one or more detected detection points and/or based on the one or more combined clusters.

2. The method according to claim 1, wherein the environment includes an origin that coincides with a position of the vehicle.

3. The method according to claim 2,
wherein each segment of a first subset of the plurality of segments is defined in terms of a respective angular aperture originating from the origin,
the first subset comprising one, more, or all segments of the plurality of segments; further
wherein the segments of the first subset comprise at least two different angular apertures, wherein
segments extending substantially in a lateral direction from the vehicle comprise a larger or a smaller angular aperture than segments extending substantially in a longitudinal direction from the vehicle and/or
wherein the segments of the first subset comprise an angular aperture originating from the origin substantially in the direction of travel of the vehicle

4. The method according to claim 3, wherein each segment of a second subset of the plurality of segments is defined in terms of a cartesian subsection, wherein the second subset comprises one, more, or all segments of the plurality of segments;
wherein segments of the second subset comprise least two different extensions in one dimension; and/or
wherein the segments of the second subset comprise a first extension extent substantially transverse to a direction of travel of the vehicle which is greater than a second extension substantially in the direction of travel of the vehicle.

5. The method according to claim 3, wherein the segments of the first subset are defined on one side of the origin and the segments of the second subset are defined on an opposite side of the origin.

6. The method according to claim 1,
wherein the combining of the one or more detection points into one or more clusters is based on the application of the Kalman filter; and wherein the one or more clusters are treated as one or more detection points.

7. The method according to claim 1, wherein the state of a segment of the plurality of segments indicates an at least partial overlap of an object with the respective segment, wherein the state includes at least one discrete value or one probability value.

8. The method according to claim 1, wherein the vehicle comprises a sensor system configured to detect the objects in the form of detection points; wherein more preferably the sensor system comprises at least a first sensor and a second sensor, and wherein the first and second sensors are configured to detect objects.

9. The method according to claim 8, wherein the first and second sensors are selected from the group comprising ultrasonic-based sensors, optical sensors, radar-based sensors, or lidar-based sensors.

10. The method according to claim 1, wherein detecting the one or more detection points comprises detecting the one or more detection points by means of a sensor system.

11. A system for detecting one or more objects in an environment of a vehicle, the system comprising a control unit and a sensor system, wherein the control unit is configured to perform the method according to claim 1.

12. A vehicle comprising the system according to claim 1.

13. The method of claim 2, wherein the origin coincides with a position of the center of a rear axle of the vehicle.

14. The method of claim 4, wherein the second subset is based on the first subset.

15. The method of claim 5, wherein the segments of the first subset are defined as originating from the origin in the direction of travel of the vehicle.

16. The method of claim 8, wherein the first and second sensors are different from each other.
